(19) United States
(12) Patent Application Publication
(10) Pub. No.: US 2004/0156599 A1
(43) Pub. Date: Aug. 12, 2004

(54) Method of splicing waveguides

(75) Inventors: John Love, Flynn (AU); Susan Hilary Law, Concord West (AU); David Thorncraft, Melba (AU); Shane Huntington, Sydenham (AU)

Correspondence Address: LADAS & PARRY, 224 SOUTH MICHIGAN AVENUE, SUITE 1200, CHICAGO, IL, 60604, US

(73) Assignees: THE UNIVERSITY OF SYDNEY, SYDNEY (AU); THE AUSTRALIAN NATIONAL UNIVERSITY, ACTON (AU); THE UNIVERSITY OF MELBOURNE, PARKVILLE (AU); AUSTRIALIAN PHOTONICS PTY LTD, EVELEIGH (AU)

(21) Appl. No.: 10/724,278

(22) Filed: Nov. 28, 2003

Related U.S. Application Data
(63) Continuation of application No. PCT/AU02/00690, filed on May 31, 2002.

(30) Foreign Application Priority Data
May 31, 2001 (AU) PR5375

(51) Int. Cl. G02B 6/26

(52) U.S. Cl. 385/98; 385/50; 385/43

(57) ABSTRACT

The present invention relates to a method of splicing together two optical waveguides, such as an optical fibre and a planar waveguide, or two optical fibres. The method involves the steps of etching a terminal end of an optical fibre in the manner so as to create a tapered core projection. Another optical fibre or waveguide has a complimentary recess etched therein. The projection and recess are placed together and the waveguides moved together to facilitate alignment of the respective cores of the waveguides. A tube etching method is utilised to create the projection.

### FIELD OF THE INVENTION

This invention relates to a method of splicing together two optical waveguides, such as an optical fibre and a planar waveguide, or two optical fibres.

### BACKGROUND OF THE INVENTION

The current method of joining an optical fibre to a planar waveguide involves the rudimentary process of butt coupling a cleaved end of the optical fibre to a blank end of the waveguide. This approach involves inherent core alignment difficulties and, consequently, has the potential to result in unacceptably high coupling losses.

The present invention seeks to alleviate these problems by providing a procedure that facilitates aligned coupling between two waveguides, such as a planar waveguide and an optical fibre or two optical fibres.

### SUMMARY OF THE INVENTION

In accordance with a first aspect of the present invention, there is provided a method of splicing a first optical waveguide, having a first core, to a second optical waveguide having a second core with a cladding, the method comprising the steps of:

(a) etching an exposed end of the first optical waveguide with a first etching solution that is selected to preferentially etch the first core, wherein the first optical waveguide is etched for a first period of time sufficient to create a recess of depth d at the end of the first optical waveguide;

(b) etching a terminal end of the second optical waveguide in a manner so as to create a projection;

(c) positioning the projection of the second optical waveguide within the recess of the first optical waveguide; and

(d) securing the projection within the recess. The projection incorporates the core and is preferably formed as a tapered end, the second waveguide core projecting to the end of the tapered end.

Preferably, in the second optical waveguide, the cladding and core may have different compositions. For example, one of the cladding or core may be doped relative to the other in order to vary their properties with respect to each other. Preferably, the first core of the first optical waveguide also has a cladding, and the material properties of the cladding are preferably different from that of the core eg. by way of relative doping.

In a preferred embodiment, the second optical waveguide comprises a first doped silica core and a silica cladding and the second optical waveguide comprises a second doped silica core with a silica cladding.

The tapered end preferably comprises a narrower terminal portion of the second optical waveguide, to be received by the recess of the first optical waveguide. Where the second optical waveguide is an optical fibre, for example, the tapered end may comprise core material surrounded by some cladding material, or comprise solely core material.

Preferably, the tapered end is secured within the recess with a bonding agent.

Preferably, the tapered end has a length 1 approximately equal to the depth d.

To position the tapered end of the second optical waveguide within the recess, preferably the tip of the tapered end is placed within the recess (though not necessarily aligned with the first optical waveguide,) and is then aligned with the first optical waveguide by moving the waveguides together. The application of this positioning step preferably results in the first and second optical waveguides being “self aligning”. Once the tapered end is placed within the recess, all that it is required for the alignment is to move the first optical waveguide and second optical waveguide together. As the tapered end moves into the recess, the first and second optical waveguides become aligned.

In one embodiment, the first optical waveguide is a planar optical waveguide and the second optical waveguide is an optical fibre.

In an alternative embodiment, both the first and second optical waveguides are optical fibres.

The tapered end may be created by a “tube etching process” preferably by the following steps:

providing an etch resistant jacket around an outside surface of the cladding such that the terminal end is left exposed;

exposing an end region of the fibre (where the second optical waveguide is a fibre) to a second etching solution for a period of time sufficient to create the core projection at the terminal end.

Preferably, the etch resistant jacket is provided with the second optical waveguide, and need not be provided as a separate step.

Preferably, the etch resistant jacket is a polymer jacket, and may be the usual polymer coating provided with an optical fibre (where the second optical waveguide is an optical fibre).

Preferably, the second etching solution comprises a hydrofluoric acid solution.

In accordance with a second aspect of the invention, there is provided a composite device having or incorporating a planar optical waveguide and at least one optical fibre which is spliced to a doped silica core of the waveguide, wherein the fibre is spliced to the planar waveguide by the above-described method.

In accordance with a third aspect of the present invention, there is provided an optical fibre comprising a first optical fibre spliced to a second optical fibre, wherein the first fibre is spliced to the second fibre by the above described method.

The present invention has the advantage of enabling the light-guiding cores of two waveguides to be automatically aligned, thereby minimising the coupling loss of light transmitted between the two waveguides. Preferably, the tapered end has a shape which compliments and meshes with the recess formed in the planar waveguide or first fibre, thus enabling the core projection to self-align with the first core when positioned within the recess.

When the first core comprises germanium-doped silica, the first etching solution preferably comprises dilute hydrofluoric acid.

The bonding agent preferably comprises an epoxy resin that is located between the tapered end and the recess. Location of the epoxy resin is most preferably effected by a capillary process.

The waveguide recess in one embodiment preferably is etched to a depth d slightly greater than the length 1 of the core projection of the optical fibre, in which case the gap between the ends of the recess and the tapered end will be occupied by the bonding agent. However, the terminal end of the optical fibre may be etched in a manner to create a tapered end having a length 1 which is slightly greater than that of the recess depth d, in which case the bonding agent will function to hold the end face of the tapered end in abutting contact with the base of the waveguide recess.

In one embodiment, the tapered end is terminated in a substantially flat surface orientated transverse to the second core and having a diameter substantially equal to that of the second core. The cladding surrounding the second core may be down tapered towards an outer edge of the end surface. In such an embodiment, the full width of the second core is presented to the recess as a substantially flat surface. The recess preferably also includes a flat surface arranged to mate with the flat end surface of the core projection.

### BRIEF DESCRIPTION OF THE DRAWINGS

Embodiments of the invention will now be described, by way of example only, with reference to the accompanying drawings.

FIG. 1 illustrates the first step of a process for forming a tapered end at the end of an optical fibre, in which an end region of a polymer-coated optical fibre is dipped into a hydrofluoric acid solution.

FIG. 2 shows the polymer-coated optical fibre of FIG. 1 after a cone-shaped tapered end has been etched.

FIG. 3 shows a photo of a tapered terminal end of an optical fibre formed in accordance with the method illustrated in FIGS. 1 and 2.

FIG. 4 is a diagram of an optical fibre with a terminal end in the form of a truncated cone.

FIG. 5 shows an optical microscope image across a recess formed in an end face of a planar waveguide.

FIG. 6 shows a plan view of the recess shown in the scan of FIG. 5.

FIGS. 7A to 7D show the insertion of the end of the tapered end of an optical waveguide into the corresponding recess of a further optical waveguide in accordance with the present invention.

### DETAILED DESCRIPTION OF PREFERRED EMBODIMENTS

Experiments that support the present invention and which embody the above features are described as follows in the context of optical fibre and a planar waveguide. However, it will be understood that the same principles apply to the splicing together of two optical fibres.

### EXAMPLE 1

### Formation of Core Projection

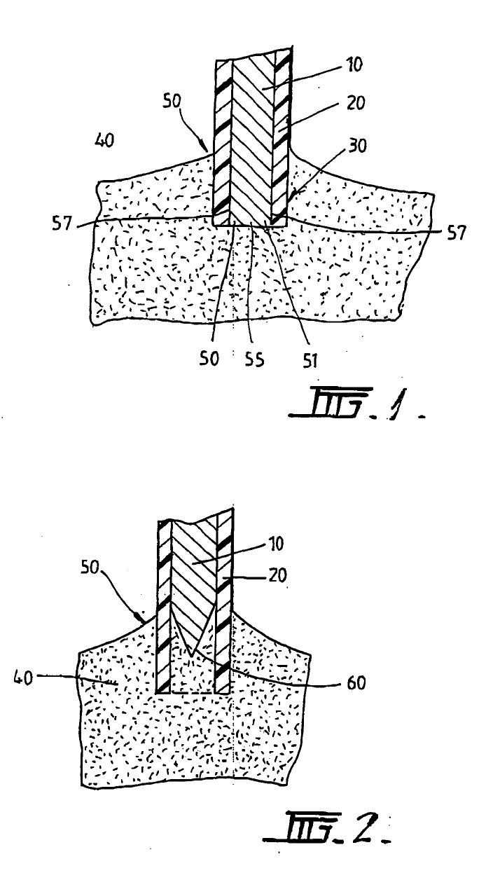

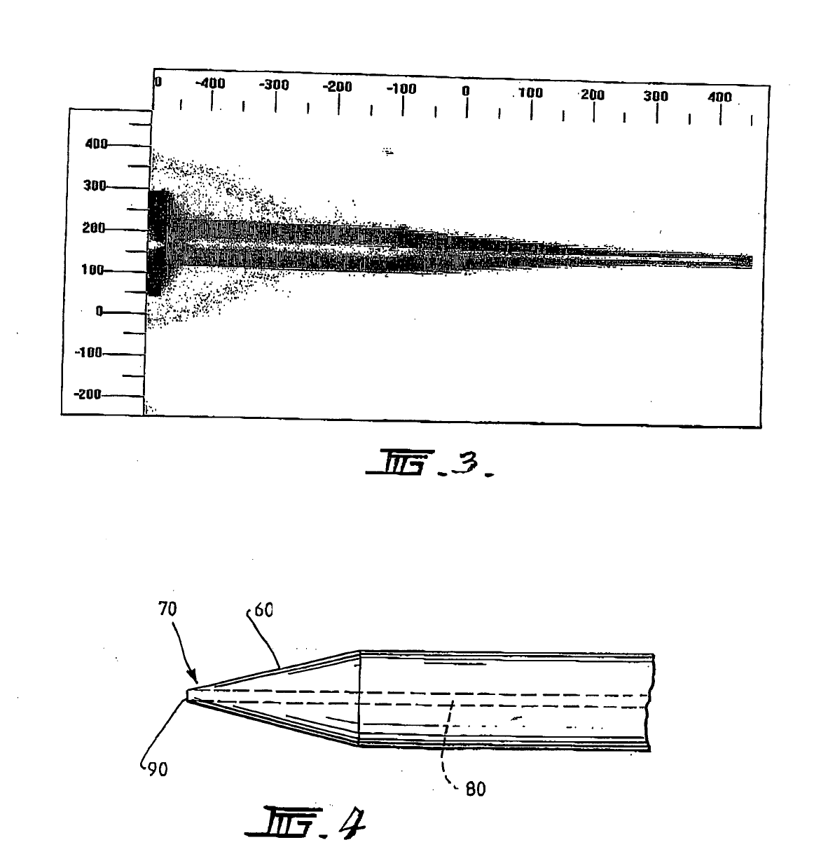

In this example, a tapered end is formed at a terminal end of an optical fibre using a method described in detail by Stockle et al (“High-quality near-field optical probes by tube etching”, Applied physics letters, 75(2) 1999). The Stockle method is described specifically for formation of near-field optical probes. In this embodiment of the present invention, the Stockle process is applied to a silica-based optical fibre 10, etching the fibre without stripping off an outer polymer coating 20. The fibre 10 is etched by dilute hydrofluoric acid. The etching process thus takes place inside a hollow cylinder formed by the fibre's protective polymer coating, which withstands degradation by the dilute hydrofluoric acid. As shown in FIG. 1, the etching process is begun by dipping an end region 30 of the optical fibre 10 in a hydrofluoric acid (HF) solution 40. A meniscus 50 is formed where the solution 40 contacts the optical fibre 10. It is believed that due to geometrical constraints, outer regions 51 of the silica-based fibre etch slightly faster than the centre 55. This is attributed to the fact that at the outer regions 51, there is a greater volume of hydrofluoric acid supply compared to the centre 55 of the fibre. After a suitable period of time, depending on the concentration of the hydrofluoric acid (and the fibre type), a conical tip 60 is formed at the terminal end of the optical fibre 10. At room temperature, the required etching time is reported by Stockle to be between 90 minutes (40% HF) and 15 hours (21% HF). Once the conical tip 60 has formed, the polymer jacket surrounding the tip can be removed either mechanically or chemically (e.g. using sulfuric acid). FIG. 3 shows a photograph of a tapered terminal end specifically shaped to fit into the waveguide recess formed at the end of an optical fibre. The tapered terminal end has been etched with the tube etching method discussed above. The polymer jacket has been stripped off the end region and is thus not present in the photographed region. The scale on the vertical axis and the scale on the horizontal axis are in microns.

FIG. 4 shows a diagram of embodiment of an optical fibre etched using the tube etching method in which the cone-shaped tip 60 has been truncated at a point 70 where the diameter of the cone matches that of the core 80. The core in this embodiment terminates in a substantially flat end surface 90. It is believed that the flat end surface 90 will result in reduced coupling losses when connected to a planar waveguide or optical fibre. Truncation of the cone-shape tip may be achieved by etching the tip again, without the coating, in HF acid. The core will etch faster than cladding and the tip will be rapidly truncated.

### EXAMPLE 2

### Formation of Recess in Planar Waveguide

A standard PECVD waveguide with a germanium-doped core, silica cladding and a silicon substrate is etched in order to create a recess within one end face. FIG. 5 of the drawings shows an optical microscope image of the cross-section of the waveguide after etching for 15 minutes using a 48% hydrofluoric acid solution. The depth of the core region of the etched socket 100 is measured to be approximately 20 microns.

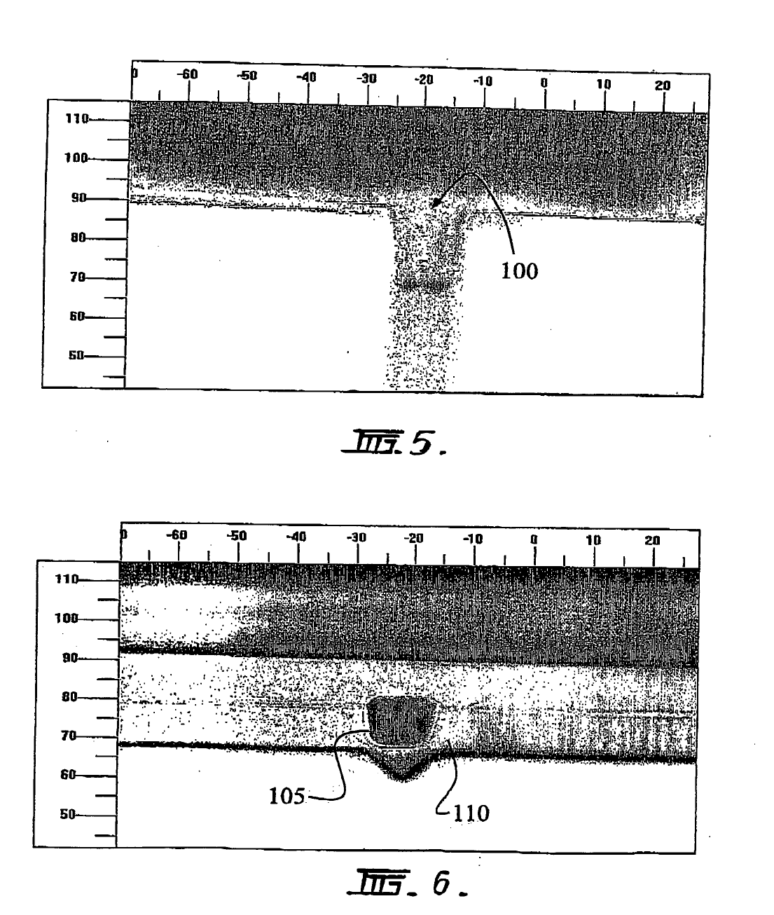

A further PECVD planar waveguide sample etched for 40 seconds using a 48% hydrofluoride solution produces a recess having a depth (d) in the order of two microns. FIG. 6 of the accompanying drawings shows a plan view of the recess 105 as etched in the end face 110 of the silica substrate in which the (etched) core is embedded.

Once a tapered end has been formed on a fibre and a recess has been formed in either a fibre or planar waveguide, the next step is to insert the tapered end into the recess and fill in any air gaps using an epoxy which is index-matched, free-flowing and UV curable. A suitable epoxy may be Epotek OG603. Finally, the outside of the fibre can be bonded to the waveguide in a number of ways, for example, by potting the joist, thus providing mechanical support to the fibre.

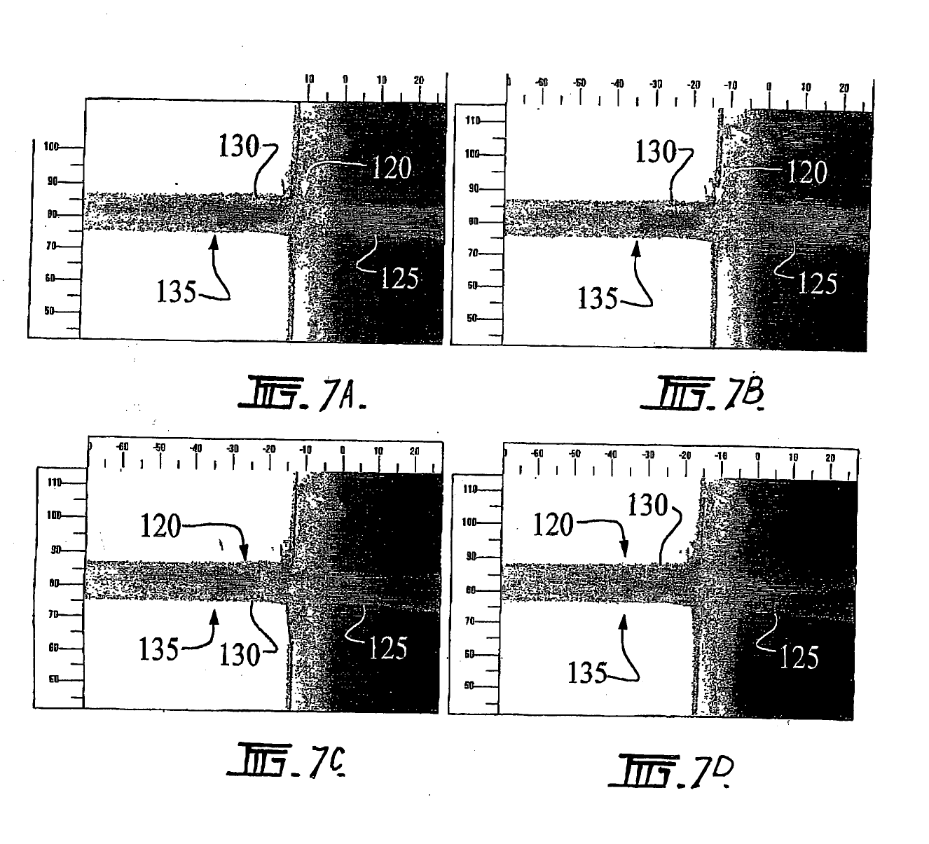

FIGS. 7 to 7D are photographs of the progressive insertion of the end 120 of a tapered end 125 of an optical waveguide formed according to the preferred process of the present invention into the corresponding recess 130 of a further optical waveguide. In each case the leading end 120 of the tapered end 125 is indicated, as is the maximum depth 135 to which it can be inserted into recess 130.

It has been found that when a planar waveguide is spliced to an optical fibre using the present invention, the efficiency of optical coupling between spliced waveguides is at least as good as splices achieved by the prior art butt coupling method. The present invention has the added advantage that the cores are self-aligning.

Although the invention has been described with reference to particular examples of etching solutions, the invention includes within its scope any etching solution capable of forming the recess and tapered end.

Although the invention has been described with reference to particular examples of waveguide materials, the invention includes within its scope any waveguide material that can be etched to form the recess and projection, such as silica, silicon, polymer, lithium niobate and others.

It will be appreciated by a person skilled in the art that numerous variations and/or modifications may be made to the present invention as shown in the specific embodiments without departing from the spirit or scope of the invention as broadly described. The present embodiments are therefore to be considered in all respects illustrative and not restrictive.

We claim:

1. A method of splicing a first optical waveguide, having a first core, to a second optical waveguide having a second core with a cladding, the method comprising the steps of:
(a) etching an exposed end of the first optical waveguide with a first etching solution that is selected to preferentially etch the first core, wherein the first optical waveguide is etched for a first period of time sufficient to create a recess of depth d at the end of the first optical waveguide;
(b) etching a terminal end of the second optical waveguide in a manner so as to create a tapered end;
(c) positioning the tapered end of the second optical waveguide within the recess of the first optical waveguide; and
(d) securing the tapered end within the recess.

2. A method in accordance with claim 1, wherein the step of positioning the tapered end of the second optical waveguide within the recess of the first optical waveguide includes the step of placing the tip of the tapered end within the recess and then aligning the first and second optical waveguides by moving the waveguides together so that the tapered end is positioned within the recess of the first optical waveguide.

3. A method in accordance with any one of the preceding claims, wherein the step of etching the terminal end of the second optical waveguide in a manner so as to create a tapered end comprises the step of applying a tube etching process to the terminal end.

4. A method in accordance with claim 3, wherein the tube etching process includes the steps of utilising an etch resistant jacket about the cladding of the second waveguide, and exposing an end region of a second waveguide to a second etching solution for a period of time sufficient to create the tapered end at the terminal end.

5. A method in accordance with any one of the preceding claims, wherein the terminal end has a length 1 approximately equal to the depth d.

6. A method in accordance with any one of claims 1 to 4, wherein the recess is etched to a depth d slightly greater than the length 1 of the tapered end.

7. A method in accordance with any of the preceding claims, comprising the step of terminating the tapered end by a substantially flat surface orientated substantially transversely to the second core.

8. A method in accordance with claim 7, wherein the step of terminating the tapered end in a substantially flat surface, comprises the step of down tapering the cladding towards the end surface, so that the substantially flat surface has a diameter substantially equal to that of the second core.

9. A method in accordance with any one of the preceding claims, wherein the first waveguide and second waveguide are optical fibres.

10. A method in accordance with any of claims 1 to 8, wherein one of the first and second optical waveguides is a planar waveguide and the other of the first and second optical waveguides is an optical fibre.

11. A method in accordance with claim 1, comprising the further step of securing the tapered end within the recess using a bonding agent.

12. A method in accordance with any one of the preceding claims, wherein the projection is in the form of a tapered end.

13. A composite device having or incorporating a planar optical waveguide and at least one optical fibre which is spliced to a doped silica core of the waveguide, wherein the fibre is spliced to the planar waveguide by the method defined in any one of claims 1 to 12.

14. An optical fibre comprising a first optical fibre spliced to a second optical fibre, wherein the first fibre is spliced to the second fibre by the method defined in any one of claims 1 to 12.
